(19) United States
(12) Patent Application Publication
(10) Pub. No.: US 2006/0248129 A1
(43) Pub. Date: Nov. 2, 2006

(54) Method and device for managing unstructured data

(75) Inventors: David Christopher Carnes, Minneapolis, MN (US); Nicholas Jeffrey Longtin, Minneapolis, MN (US)

Correspondence Address: David C Cames;c/o Arcstone, 2937 Lyndale Ave. South, Minneapolis, MN, 55408, US

(73) Assignee: Wonderworks LLC

(21) Appl. No.: 11/148,757

(22) Filed: Jun. 9, 2005

Related U.S. Application Data
(60) Provisional application No. 60/676,192, filed on Apr. 29, 2005.

(51) Int. Cl. G06F 17/30

(52) U.S. Cl. 707/204

(57) ABSTRACT

Methods and systems for managing unstructured data. Embodiments involve providing a portion of data within a client in the networked computing system. A profile is created that is associated with the portion of data, the profile having at least a first user defined label and a user identifier. The portion of data and the profile are transmitted from the client to a server in the networked computing system. The portion of data, for example, a file, and the first user defined label are automatically stored into a data structure, such as a file and an associated database, on the server in response to receipt of the portion of data and the profile by the server. The data structure is subsequently identified in response to a query by the user seeking data associated with the first user defined label.

### RELATED PATENT DOCUMENTS

This application claims the benefit of Provisional Patent Application Ser. No. 60/676,192, filed on Apr. 29, 2005, to which priority is claimed pursuant to 35 U.S.C. §119(e) and which is hereby incorporated herein by reference.

### FIELD OF THE INVENTION

The invention relates generally to computer file storage systems and methods, and more particularly to computer systems and methods that manage unstructured data.

### BACKGROUND OF THE INVENTION

Individual disk capacity has grown at roughly seventy percent (70%) per year from 1994 to 2004 in the United States (US). Typically, consumers use their computers primarily for communication and organizing personal information, whether it is traditional personal information manager (PIM) style data or media such as digital music or photographs. The amount of digital content, and the ability to store the raw bytes, has increased tremendously; however, the methods available to consumers for organizing and unifying this data has not kept pace. Knowledge workers spend considerable time managing and sharing information, and some studies estimate that knowledge workers in the US in 2004 spent 15-25% of their time on non-productive information related activities.

Traditional approaches to the organization of information in computer systems have centered on the use of file-folder-and-directory-based systems to organize groups of files into directory hierarchies of folders based on an abstraction of the physical organization of the storage medium used to store the files. The Multics operating system, developed during the 1960s, can be credited with pioneering the use of the files, folders, and directories to manage storable units of data at the operating system level. Specifically, Multics used symbolic addresses within a hierarchy of files (thereby introducing the idea of a file path) where physical addresses of the files were not transparent to the user (applications and end-users). This file system was entirely unconcerned with the file format of any individual file, and the relationships amongst and between files was deemed irrelevant at the operating system level (that is, other than the location of the file within the hierarchy).

Since the advent of Multics, storable data has been organized into files, folders, and directories at the operating system level. These files generally include the file hierarchy itself (the “directory”) embodied in a special file maintained by the file system. This directory, in turn, maintains a list of entries corresponding to all of the other files in the directory and the nodal location of such files in the hierarchy (herein referred to as the folders).

However, while providing a reasonable representation of information residing in the computer's physical storage system, a file system is nevertheless an abstraction of that physical storage system, and therefore utilization of the files requires a level of indirection (interpretation) between what the user manipulates (units having context, features, and relationships to other units) and what the operating system provides (files, folders, and directories). Consequently, users (applications and/or end-users) have no choice but to force portions of data into a file system structure even when doing so is inefficient, inconsistent, or otherwise undesirable. Moreover, existing file systems know little about the structure of data stored in individual files and, because of this, most of the information remains locked up in files that may only be accessed (and comprehensible) to the applications that wrote them. Consequently, this lack of mechanisms for managing information leads to the creation of silos of data. Because most existing file systems utilize a nested folder metaphor for organizing files and folders, as the number of files increases the effort necessary to maintain an organization scheme that is flexible and efficient becomes quite daunting.

Several unsuccessful attempts to address the shortcomings of file systems have been made in the past. Object-oriented database (OODB) systems have been made, but these attempts, while featuring strong database characteristics and good non-file representations, were not effective in handling file representations and could not replicate the speed, efficiency, and simplicity of the file and folder based hierarchical structure at the hardware/software interface system level.

### SUMMARY OF THE INVENTION

The present invention is directed to systems and methods for managing unstructured data. Embodiments of methods of the present invention may involve providing a portion of data within a client in the networked computing system. A profile is created that is associated with the portion of data, the profile having at least a first user defined label and a user identifier. The portion of data and the profile are transmitted from the client to a server in the networked computing system. The portion of data and the first user defined label are automatically stored into a data structure on the server in response to receipt of the portion of data and the profile by the server. The data structure is subsequently identified in response to a query by the user seeking data associated with the first user defined label.

According to another embodiment, a system includes a client configured to provide a portion of data, and to associate the portion of data with a profile, the profile having a first user defined label and a user identifier. A server is communicatively coupled to the client, the server configured to receive the portion of data and the profile from the client, and to automatically store the portion of data and the first user defined label into a data structure on the server in response to receipt of the portion of data and the profile by the server. The server is further configured to identify the data structure in response to a query by the user seeking data associated with the first user defined label.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is a block diagram of a profile based data management system for managing unstructured data in accordance with embodiments of the present invention;

FIG. 2 is a block diagram of file management using a profile based data management system versus a typical file management system of files and folders;

FIG. 3 is a block diagram illustrating a profile associated with a portion of data in accordance with embodiments of the present invention; and

FIG. 4 is a flowchart of a method of managing unstructured data in accordance with embodiments of the present invention.

While the invention is amenable to various modifications and alternative forms, specifics thereof have been shown by way of example in the drawings and will be described in detail below. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION OF VARIOUS EMBODIMENTS

The present invention is believed to be applicable to a variety of systems and approaches involving management of unstructured data. Aspects of the invention disclosed below are described in the context of a client-server relationship. While the present invention is not necessarily limited to client-server applications, an appreciation of various aspects of the invention is best gained through a discussion of examples in such an environment. However, point-to-point (P2P) systems or other arrangements for purposes herein shall be considered as variations of a client-server system. For example, in a P2P system involving two data processing systems, one system may be considered as the client, and the other system may be considered as the server, without departing from the scope of the present invention.

In the following description of the illustrated embodiments, references are made to the accompanying drawings, which form a part hereof, and in which are shown by way of illustration, various embodiments by which the invention may be practiced. It is to be understood that other embodiments may be utilized, and structural and functional changes may be made without departing from the scope of the invention.

Methods, devices and systems in accordance with the present invention may include one or more of the features, structures, methods, or combinations thereof described herein. It is intended that methods, devices and systems in accordance with the present invention need not include all of the features and functions described herein, but may be implemented to include selected features and functions that provide for useful structures and/or functionality.

As data volume increases, such as with a large number of files, managing the data becomes increasingly burdensome. For example, during product development cycles, many projects, research documents, spreadsheets, reports, and other data may be generated. Typically this data is stored in a file structure, such as by using directories, subdirectories, and files. Large volumes of data often make it difficult to retrieve a desired portion of data when this structure is utilized. A user may ask such questions as “What did I do with that proposal last year? What folder did I put it in?”

Research into worker efficiency suggests that the average knowledge worker may spend as much as 2.5 hours per day panning for information nuggets in unstructured sources like web pages and document files, even though many of those pages and files may be their own, when working within the file structure system described above. Typically, 85% of the data in an organization may be unstructured (not in a database). The amount of unstructured data in an average business may double every three months.

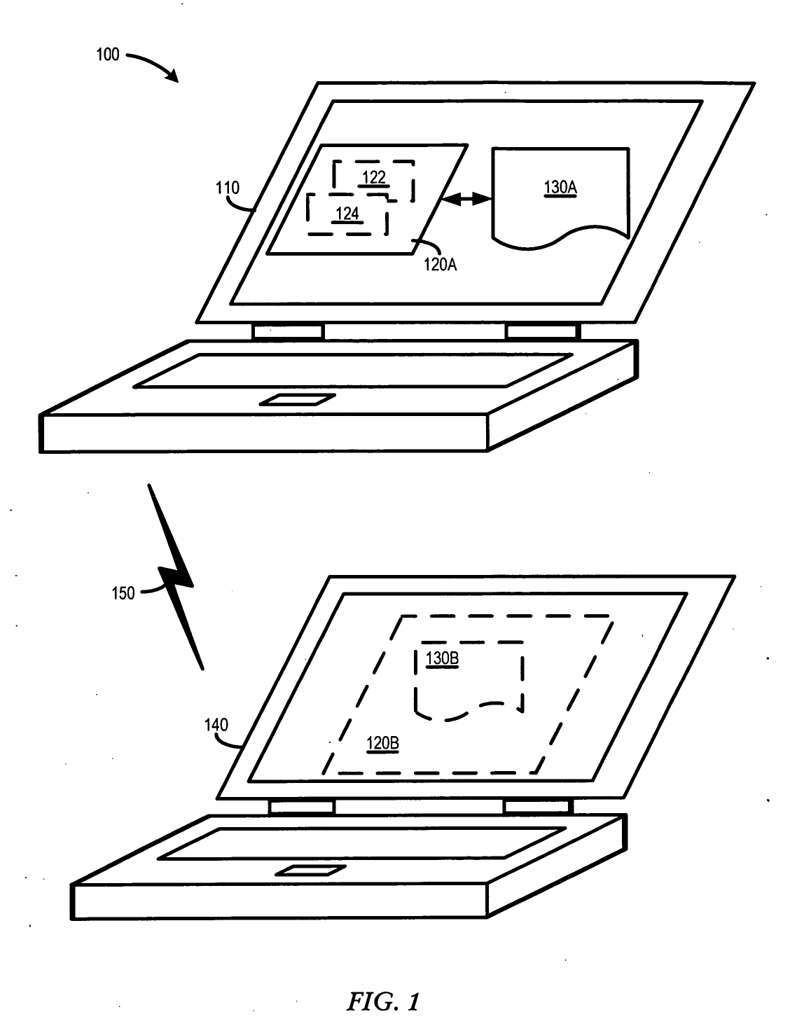

FIG. 1 is a block diagram of a profile based data management system 100 for managing unstructured data in accordance with embodiments of the present invention. The embodiment of the present invention illustrated in FIG. 1 is directed to the profile based data management system 100 useful for managing unstructured data, such as word files, spreadsheets, pictures, documents, video data, email, web addresses, audio files, or other unstructured data. A portion of data 130A is provided within a client 110 in profile based data management system 100. A profile 120A is created that is associated with the portion of data 130A, the profile 120A having at least a first user defined label 122 and a user identifier 124. The portion of data 130A and the profile 120A are transmitted from the client 110 to a server 140 in the profile based data management system 100. The portion of data 130A, for example, a file, and the first user defined label 122 are automatically stored into a data structure 120B, such as a file 130B and the information contained in the profile 120A, on the server 140 in response to receipt of the portion of data 130A and the profile 120A by the server 140. The data structure 120B is subsequently identified in response to a query by the user seeking data associated with the first user defined label 122, as will be illustrated in more detail below.

One example of the profile 120A is herein designated as a WONDERFILE, a trademark of Wonderworks LLC, Minneapolis Minn. Wonderworks provides an online service that, in one example embodiment, integrates with popular electronic messaging platforms, such as MICROSOFT OUTLOOK (a Trademark of Microsoft Inc., Redmond, Wash.) and saves individuals and teams valuable time by making it faster and easier to find, share and manage digital files and information in accordance with embodiments of the present invention. For example, one or more profiles may be used to backup data, share files, store and search files, date/time stamp the actual time the file was uploaded, access files from any Internet connected computer, keep track of important files and information, store files so other people can find them, find files associated with user queries, and perform other data management activities as disclosed herein. In a further example embodiment of using a profile to organize web pages, a profile based data management system can label and save web addresses (URLs), and find what is needed again, quickly.

Other embodiments of the present invention are directed to a hybrid data management system including a digital file library, knowledge base, and collaboration platform. The data management system improves upon known file management models, using a label oriented design and electronic messaging integration that makes storing, sharing, tracking and archiving many kinds of files, in many formats, simple and efficient, as will be described further below.

Profile based data management systems and methods provide users with the ability to manage and share many kinds of files. Files may be loaded, for example, using a website or electronic messaging. Files can be loaded one at a time or concurrently. Files may be loaded via electronic messaging associated with a profile, herein designated Wondermail, by attaching a profile to an electronic message, for example, and sending the electronic message to a predetermined address designating a server in the data management system.

A profile based data management system uses labels instead of folders to organize files. For example, a profile may provide labels that are automatically added to every file. A non-exhaustive, non-limiting list of labels that may be provided includes: defining the user, company, date uploaded, file type, size information, file type (extension, ASCI/Binary, vendor, for example), file meta (created, updated and accessed for example), extended file meta (author and company, for example), person sending, person company, person IP/Other hardware, network info, person OS/version, other software version information, recipients, associated emails, associated account information, or the like. Wondermail allows users to assign labels and set permissions right in the electronic messaging, eliminating the need to also log into a separate website. Moreover, users can add labels to the file later from the web interface. Labels may be added, edited and deleted by users in a label management section of the server, for example, as will be described further below.

Users of profile based data management systems have the capability to find files using refined search criteria. The user may specify any number of labels they want the “found files” to include, or exclude. Users can also refine a search by defining the date uploaded or edited, file type and keywords. The user can also sort the search results. From the search results list, users may edit labels, permissions, and delete multiple files at a time. Search criteria can be saved for quick access at a later time. By saving the criteria rather than the result, searches are always reflecting the latest database information in accordance with the present invention.

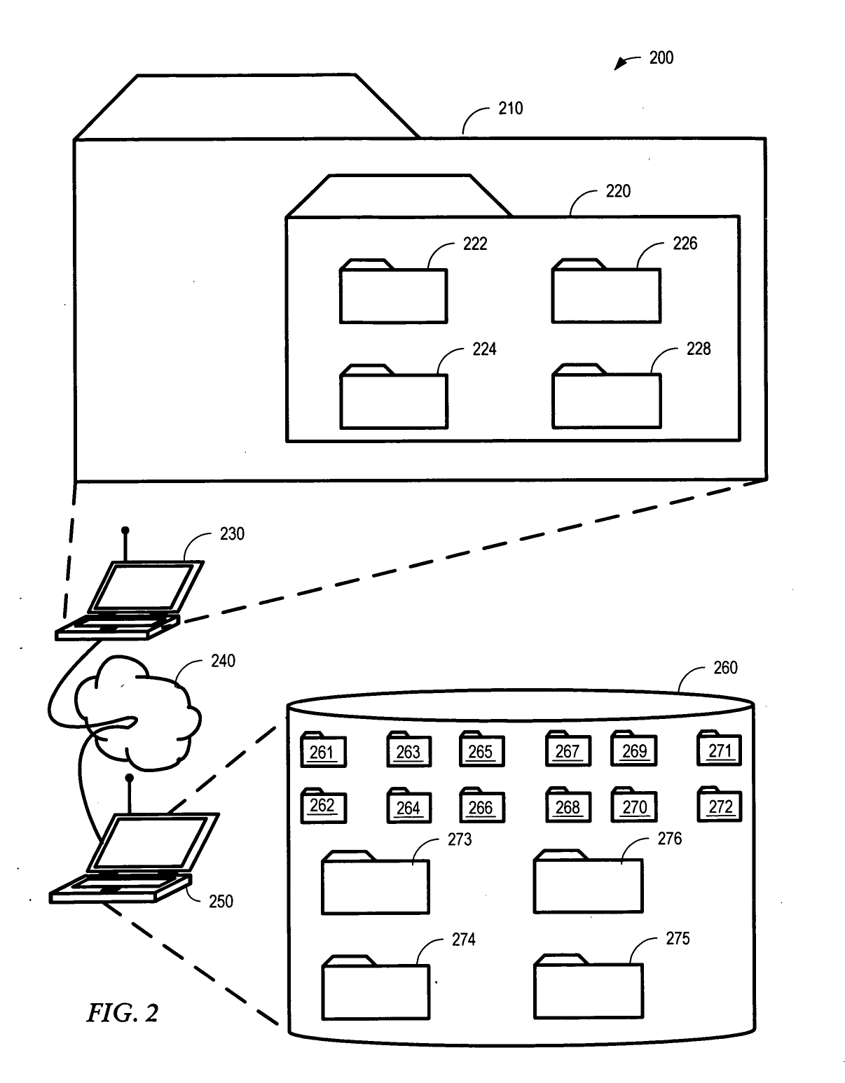

A profile based data management system uses a folder-less, label oriented design. Systems and methods in accordance with the present invention make various types of files accessible from anywhere with Internet connection. Profile based data management systems may reduce or eliminate the need for disks that can be forgotten or lost. Referring now to FIG. 2, a non-limiting example of a profile based data management system 200 in accordance with the present invention is compared to a typical file-based management system 210, resident on a client system 230. A server 250 is illustrated as configured to use a profile base data management methodology. The server 250 includes memory, designated as a data pile 260. A network system, such as an internet system 240 communicatively connects the client 230 to the server 250, for example using wireless, Ethernet, telephone, or other connection technology.

Typically, in file-based management system 210, files such as, for example, documents, are created and placed in a folder 222, 224, 226, 228 that is located in a directory 220. Folders may be nested in complex arrangements of directories and subdirectories. But basically, a file or document may only be put it in one place. This methodology restricts the accessibility of the data. For example, directory and folder based systems create problems if the document belongs in more than one place. If multiple copies of the document are placed into multiple folders, then other problems arise, such as revisions being difficult to manage and memory space being squandered.

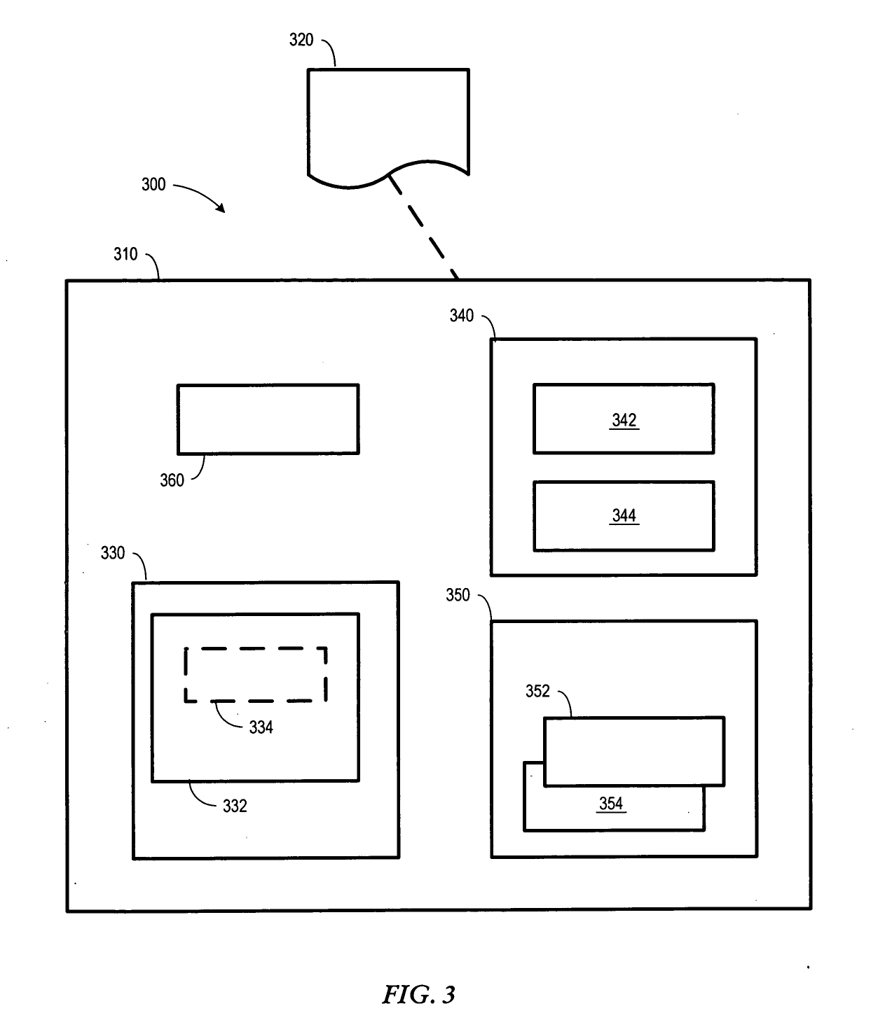

Referring now to both FIG. 2 and FIG. 3, for purposes of clarity and not as limitation, an example will be described referring to an individual, designated as David, working on a plan for marketing white elephants with custom headdresses to high technology and healthcare companies. FIG. 3 is a block diagram illustrating a profile, designated as WONDERFILE 310, associated with a portion of data 320 in accordance with embodiments of the present invention. The portion of data 320, in the particular example, is David's marketing plan, designated as elephantplan.doc. In the folder-based system 210, indecision may occur relative to which file the plan should be placed into. Folders won't solve David's problem, because folders organize data by location. David is forced to choose a single location (one folder) for his file if he only has access to the folder-based system 210. David may choose to place the file in the folder 222, which may be designated as relating to elephants, the folder 224, which may be designated as relating to high technology marketing trends, the folder 226, which may be designated as relating to healthcare marketing trends, and/or folder 228, which may be designated as relating to marketing plans. Regardless of David's choice, the abovementioned problems will arise due to the directory and folder based system 210.

By using the profile based data management system 200, everything goes in the big digital pile 260 that is accessible from many criteria, the criteria resident in the WONDERFILE 310. When the need arises to find an existing portion of data, the profile based data management system 200 finds the file using the criteria, also designated as labels, to recover the portion of data from the pile. The profile based data management system 200 uses labels, instead of folders, to describe and categorize the content of the files. Referring again to the example of David's marketing plan, when David is ready to upload his file, the WONDERFILE 310 (in this particular example embodiment) automatically labels it by a user name 360, a date uploaded 350, and file type 330. For example, David may use pick lists to choose relevant labels (which he can add, delete, group and categorize). If he wants to, he can also add a description 340 and keywords 342, 344. For example, using the above described elephantpan.doc, David may choose a list of keywords to associate with the WONDERFILE 310 to include elephants, high technology marketing trends, healthcare marketing trends, and marketing plans, as well as other keywords and/or phrases. At the same time, he can choose who can, and cannot, access his file. For example, the file type 330 may include one or more designators 332 defining access to the file. Further, a criteria 334 may be added to further limit access, for example allowing some users to view the file only, while other users may edit the file.

The date uploaded 350 may further include a revision tracking 352 and an editing criteria 352 to address some of the problems identified with directory and folder based systems. For example, the editing criteria 352 may be used to check-in and check-out the document for editing, such that only the most recent revision is available to users, and multiple users cannot simultaneously edit a document, leading to revision errors.

After the file is uploaded to the server, anyone with proper permission can search for the file, even without knowing the filename, the folder, or paging through long lists of keyword results. Use of the WONDERFILE 310 finds files by content, not location.

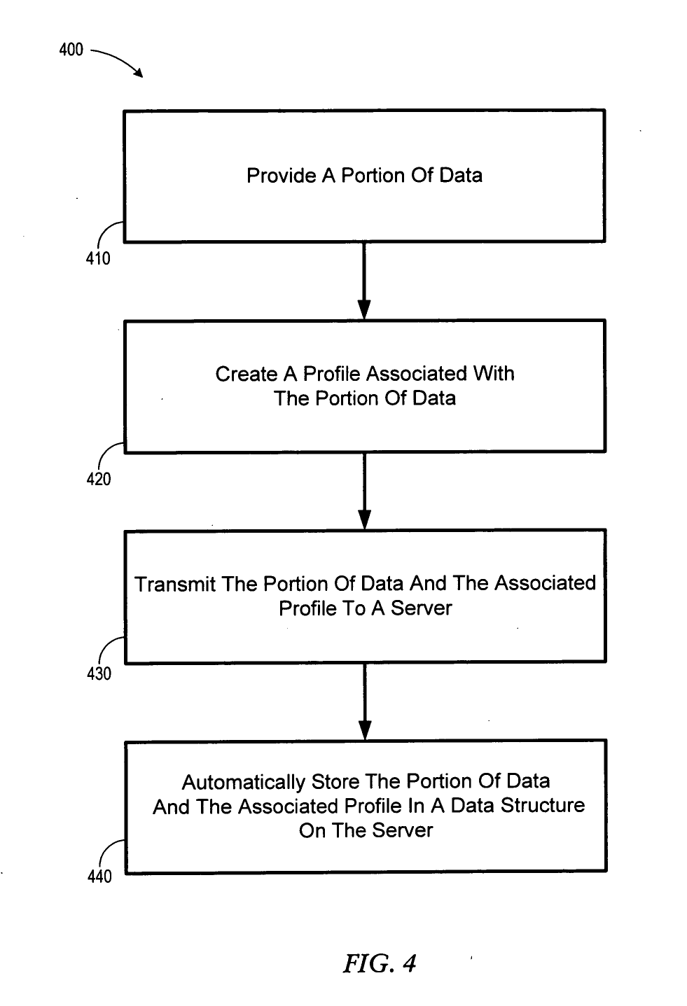

FIG. 4 is a flowchart of a method 400 of managing unstructured data in accordance with embodiments of the present invention. The method 400 involves providing 410 a portion of data within a client in the networked computing system. A profile is created 420 that is associated with the portion of data, the profile having at least a first user defined label and a user identifier. The portion of data and the profile are transmitted 430 from the client to a server in the networked computing system. The portion of data and the first user defined label are automatically stored 440 into a data structure on the server in response to receipt of the portion of data and the profile by the server. The data structure is subsequently identified 450 in response to a query by the user seeking data associated with the first user defined label.

Referring now to FIGS. 1 through 4, a non-exhaustive, non-limiting series of examples are provided below of embodiments of management of unstructured data in accordance with the present invention. In an example embodiment, profiles may be used to communicate with customers by storing and categorizing all the information for a particular client in one place. Data for particular clients may be labeled by project, people, topic, task, or whatever label is desired, including, but not limited to: keyword, key phrase, access authorization, expiration date, corroboration key, document history, file type, file size, revision tracking or other user-defined or system defined label.

In another example, documents may be shared with a committee, and user access to a group shared document may be limited by duration of time, number of downloads, access expiration date, password, or other limitation to access. A data management system in accordance with the present invention may keep a library of files that may be uploaded, downloaded, checked out, checked in, accessed, read, and edited. Access and editing permission may be controlled on a case-by-case basis. Control may be exercised in a hierarchical user structure, such as by designating users as owners, administrators, users, limited users, or other user limitation. Documents and/or data in the library may include a label in an associated profile that provides a corroboration key, which may be used to verify and/or corroborate the data and/or file as to its contents, and the date the contents were placed in the library. This may be useful, for example, to corroborate dates for invention disclosures, corroborate existence of data, or the like.

For example, coordination of a project may be improved using a profile based data management system. Users may set up project names, vendors, cities, and more as labels for files. With a few clicks, users can assign labels to the files as they email them to one another and “CC” the system. The result: a library of project-related content, including emails and attachments, that is always up to date and perfectly organized. For purposes herein, the term email is used herein to generally refer to any electronic message and/or messaging service such as, for example SMS messaging, instant messaging (such as, AIM, ICQ, MSN), electronic mail messaging, Twain, HTTP, SMTP, POP3, or the like.

In a further example embodiment of using a profile to organize data, profile can be used with big files. For example, if there is a need to share a big file, such as a high-resolution graphic, or a video clip that's too big for email, a profile may be used in accordance with the present invention to label it and upload it. Colleagues may then be sent an email with a link, and everyone desired gets fast access.

In still a further example embodiment of using a profile to organize revisions and editing, a profile based data management system can be used to collaborate on a document. Instead of emailing versions and iterations around in circles, multiple authors can check files in and out in order to edit them, reducing confusion, rewrites, and overwrites. Users may keep track of important changes to files. Users can select files or labels to watch. Email notifications can be sent to users when a file has been uploaded, downloaded, edited, deleted, checked in or out. Selecting labels to watch allows users to be notified when a new file is added under a specific label or when the label information has changed. Account owners may have the ability to check back in any file.

In a further example embodiment of using a profile to manage unstructured data, users can access files from anywhere, such as a user's home, a customer's office, the airport, the hotel. Only a web browser and an Internet connection is needed. If a user has more than one computer, he doesn't need to worry about accidentally forgetting or overwriting a file. Further, the profile based data management system may be used with redundant servers to reduce lost data in the case of system failures. For example, one server may reside inside a firewall of an entity, and a redundant system may be securely linked for automated backups. The profile label for revision tracking may be used to only backup data that is new, or that has been updated since the last backup.

In another example embodiment of using a profile to manage unstructured data, profiles may be used in coordination with virus scanning, data compression, and encryption of data. For example, a profile label may include encryption, compression, or virus scanning information associated with the files and/or data, including, for example, date and/or time information for the most recent virus scan, compression type, or other information.

A data management system in accordance with the present invention may be used to search for files or other portions of data by any combination of user defined labels such as may be user defined and/or system defined within a profile. Labels may be descriptive titles that administrators manage, for example. Label classes may be the top-level labels that other labels may be grouped under, and may include levels of sub-classes. A label class or category may be, for example, “document type”, which could contain the labels “budget”, “proposal”, “project plan” and “policies”. Label Groups may be defined that are special labels that contain any number of other labels and provide a quick way of adding several commonly used labels to a file at once. Labels may include a tiered structure, hierarchy, or other group structure and may include a label weight that may be used to prioritize search responses, for example.

Results from profile searches may be sorted by date, name and file type similarly to folder-based systems. Recent files may appear in an alternative color, as may files that are currently checked out. Users may check out/in, delete, assign labels or view the details of more than one file at once. In an example embodiment, users may track files in their “library.” When a file is modified, the user may receive an email and link to download the updated version. Email reminders may be sent to users who don't check files back in after a designated time. Users can choose to be updated of each change immediately or receive a daily digest of all changes made to the system that day.

In accordance with a further embodiment of using a profile to manage unstructured data, labels may be managed. Labels may be added, edited and deleted. Labels and label categories can also be merged or split and labels can be moved from one category to another. For example, when a category or label is edited the change may be reflected in the system and all files will show the updated information. When labels are deleted they may be automatically removed from all files and label groups. Labels may also be archived to manage older or no longer used labels. Archived labels may be reactivated, and will still show up in groups they are associated with.

A number of the examples presented herein involve block diagrams illustrating functional blocks used for managing unstructured data in accordance with embodiments of the invention. It will be understood by those skilled in the art that there exist many possible configurations in which these functional blocks may be arranged and implemented. The examples depicted herein provide examples of possible functional arrangements used to implement the approaches of the invention.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features.

Various modifications and additions can be made to the embodiments discussed hereinabove without departing from the scope of the present invention. Accordingly, the scope of the present invention should not be limited by the particular embodiments described above, but should be defined only by the claims set forth below and equivalents thereof.

What is claimed is:

1. A method in a networked computing system for a user to manage unstructured data, comprising:
providing a portion of data within a client in the networked computing system;
creating a profile associated with the portion of data, the profile comprising a first user defined label and a user identifier;
transmitting the portion of data and the profile from the client to a server in the networked computing system;
automatically storing the portion of data and the first user defined label into a data structure on the server in response to receipt of the portion of data and the profile by the server; and
identifying the data structure in response to a query by the user seeking data associated with the first user defined label.

2. The method of claim 1, wherein transmitting the portion of data and the profile from the client to the server in the networked computing system comprises automatically transmitting any portion of data identified in the client if the portion of data is associated with the profile.

3. The method of claim 1, wherein transmitting the portion of data and the profile from the client to the server in the networked computing system comprises automatically transmitting any file attached to an electronic message if the electronic message comprises the profile.

4. The method of claim 1, wherein transmitting the portion of data and the profile from the client to the server in the networked computing system comprises automatically transmitting any file attached to an electronic message if the electronic message comprises a recipient associated with a profile.

5. The method of claim 1, wherein the profile further comprises a list of approved users, the method comprising enabling access to the data structure by each user in the list of approved users.

6. The method of claim 1, wherein transmitting the portion of data and the profile from the client to the server in the networked computing system comprises automatically transmitting any file attached to an electronic message if the electronic message comprises the profile, and wherein automatically storing the portion of data and the profile into the data structure on the server comprises updating the profile by adding a recipient list of the electronic message as a second label.

7. The method of claim 1, wherein automatically storing the portion of data and the profile into the data structure on the server comprises creating a URL associated with the portion of data, and wherein identifying the data structure as associated with the user defined label comprises identifying the URL.

8. The method of claim 1, wherein the profile comprises a second user-defined label selected from the list consisting of a keyword, key phrase, access authorization, expiration date, access authorization expiration date, corroboration key, document history, file type, file size, number of download limit, label weight, and revision tracking.

9. A networked computing system for a user to manage unstructured data, the system comprising:
a client configured to provide a portion of data, and to associate the portion of data with a profile, the profile comprising a first user defined label and a user identifier; and
a server communicatively coupled to the client, the server configured to receive the portion of data and the profile from the client, and to automatically store the portion of data and the first user defined label into a data structure on the server in response to receipt of the portion of data and the profile by the server, the server further configured to identify the data structure in response to a query by the user seeking data associated with the first user defined label.

10. The system of claim 9, wherein the client is further configured to automatically transmit, to the server, any portion of data identified in the client if the portion of data is associated with the profile.

11. The system of claim 9, wherein the client is further configured to automatically transmit, to the server, any file attached to an electronic message if the electronic message comprises the profile.

12. The system of claim 9, wherein the client is further configured to automatically transmit, to the server, any file attached to an electronic message if the electronic message comprises a recipient associated with the profile.

13. The system of claim 9, wherein the profile further comprises a list of approved users, the server further configured to enable access to the data structure by each user in the list of approved users.

14. The system of claim 9, wherein the server is further configured to receive any file attached to an electronic message if the electronic message comprises the profile, and to update the profile by adding a recipient list of the electronic message as a second label.

15. The system of claim 9, wherein the profile further comprises a list of approved users, and wherein the server is further configured to create a URL associated with the portion of data, and identify the URL in response to a query by an approved user identified in the list of approved users, the approved user seeking data associated with the first user defined label.

16. The system of claim 9, wherein the profile comprises a second user-defined label selected from the list consisting of a keyword, key phrase, access authorization, expiration date, access authorization expiration date, corroboration key, document history, file type, file size, number of download limit, label weight, and revision tracking.

17. A networked computing system for a user to manage unstructured data, the system comprising:
means for providing a portion of data within a client of the networked computing system;
means for creating a profile associated with the portion of data, the profile comprising a first user defined label and a user identifier;
means for transmitting the portion of data and the profile from the client to a server in the networked computing system;
means for automatically storing the portion of data and the first user defined label into a data structure on the server in response to receipt of the portion of data and the profile by the server; and
means for identifying the data structure in response to a query by the user seeking data associated with the first user defined label.

18. The system of claim 17, comprising means for automatically transmitting any portion of data identified in the client if the portion of data is associated with the profile.

19. The system of claim 17, comprising means for enabling access to the data structure by each user in a list of approved users.

20. A computer-readable medium having computer-executable instructions for managing unstructured data, the computer-executable instructions performing steps comprising:
providing a portion of data within a client in a networked computing system;
creating a profile associated with the portion of data, the profile comprising a first user defined label and a user identifier;
transmitting the portion of data and the profile from the client to a server in the networked computing system;
automatically storing the portion of data and the first user defined label into a data structure on the server in response to receipt of the portion of data and the profile by the server; and
identifying the data structure in response to a query by the user seeking data associated with the first user defined label.
